(19) United States
(12) Patent Application Publication
(10) Pub. No.: US 2024/0102670 A1
(43) Pub. Date: Mar. 28, 2024

(54) METHOD FOR OPERATING A HEAT PUMP

(71) Applicant: Viessmann Climate Solutions, Allendorf (DE)

(72) Inventors: Egbert Tippelt, Brandenburg (DE); Christoph Meyer, Bad Laasphe (DE); Christian Berreth, Frankenberg (DE)

(21) Appl. No.: 18/255,469

(22) PCT Filed: Dec. 3, 2021
(86) PCT No.: PCT/EP2021/084158

§ 371 Date: Jun. 1, 2023

(30) Foreign Application Priority Data
Dec. 10, 2020 (DE) 10 2020 215 669.7

(51) Int. Cl. F24D 17/02; F24D 3/18; F24D 19/10; F24H 15/258; F24H 15/395

(52) U.S. Cl. CPC F24D 17/02; F24D 3/18; F24D 19/1072; F24H 15/258; F24H 15/395; F24D 2200/08; F24D 2200/12

(57) ABSTRACT

A method for operating a heat pump (1) which transfers heat to a fluid heat transfer medium which circulates in a heating circuit is provided. An outside temperature is acquired. When the outside temperature is higher than a limit temperature, a runtime of an electric heating rod (2) of the heat pump (1) and/or energy consumed by the heating rod (2) are acquired. When the runtime exceeds a first limit value within a specified period of time and/or the energy consumed by the heating element (2) in the specified period of time exceeds a second limit value, a message is output.

### METHOD FOR OPERATING A HEAT PUMP

The present invention relates to a method for operating a heat pump with a heating rod. In particular, the method is to prevent the heating rod of the heat pump from being operated unintentionally when the outside temperature is above a limit temperature. As a result, an unnecessarily high energy consumption and correspondingly high costs can be avoided.

In order to save costs, heat pumps used to heat a building and/or provide hot water are usually not configured for the absolute lowest possible temperatures in a specific location over the year. Instead, heat pumps often have an electric heating rod in order to provide additional heat output when the heat pump alone can no longer deliver the required heat output. This may be the case in particular when the outside temperatures are very low. Air-to-water heat pumps in particular work less efficiently at particularly low outside temperatures.

An electric heating rod is less efficient than a heat pump and can only generate one kilowatt hour of heat energy from one kilowatt hour of electrical energy in the ideal case. The heat pump, on the other hand, is significantly more efficient and, depending on the outside conditions, can generate 3 to 4 kilowatt hours of heat energy from one kilowatt hour of electrical energy. A long-term operation of the heating rod is therefore undesirable from an economic point of view and should be avoided if possible. In particular, the heating rod should only be operated when the heat pump alone cannot provide sufficient heat output.

On the other hand, long-term and/or frequent operation of a heating rod may provide an indication that the heat pump or another part of a heat pump heating system is defective and/or needs maintenance. In order to ensure efficient and economical operation of a heating system with a heat pump, it is therefore desirable to have the capability to reliably and quickly identify long-term and/or frequent operation of the heating rod in order to be able to take appropriate countermeasures.

A heat pump with an additional electrical heating element is described, for example, in DE 699 25 389 T2. When the outside temperature is below a limit value, the additional electric heating element is activated in order to heat up air supplied to the heat pump.

The object of the present invention is to overcome the problems known in the prior art and to provide an improved method for operating a heat pump compared to the prior art. The object is achieved by the method according to claim 1. Further aspects of the invention are the subject matter of the dependent claims, the following description of the exemplary embodiments and the drawings.

A heat pump according to the invention transfers heat to a fluid heat transfer medium which circulates in a heating circuit. The fluid heat transfer medium may, in particular, be water. In particular, the heating circuit may be configured as a system of pipes or lines in which the heat transfer medium circulates. In addition, a plurality of radiators may be arranged in the heating circuit to transfer the heat from the heat transfer medium to the air in the room.

The heating circuit may be divided into more than one hydraulic circuit which are separated according to heating purpose, for example. For example, the flow from the heat pump may branch into two or more flow lines. A first flow may be provided for heating rooms, for example via radiators or underfloor heating. A second flow may be provided for hot water, namely lead to taps in the building where hot water can be tapped, for example. Alternatively, a flow may lead from the heat pump to a hot drinking water store, where the heat transfer medium heated by the heat pump can transfer heat to drinking water. Here, the heat transfer medium may circulate from the heat pump in a closed circuit.

The heating circuit may further include a heat store, for example a hot water store. The heat pump, a control device for the heat pump, the heating circuit, the heat store and the radiator form a heating system for providing heat, for example for heating a building. In particular, the hot water store may be arranged in the second flow. The hot water tank may be, for example, a hot drinking water store as described above.

The heating system preferably includes an outside temperature sensor for detecting an outside temperature of the building. The heat pump includes an electric heating rod for transferring heat to the fluid heat transfer medium. The control device is used to control an operating state of the heat pump and the heating rod. The control device is configured to carry out a method according to the invention for operating the heat pump.

The control device may be configured to set a storage temperature of the heat store as a function of the acquired runtime of the heating rod and/or the energy consumed by the heating rod and as a function of the first and second limit values.

In particular, an outside temperature may be sensed by an outside temperature sensor. Alternatively, the outside temperature may also be sensed in a different way. For example, the outside temperature may be received from a server via a network or transmitted from another external device to the control device of the heat pump.

When the outside temperature is higher than a limit temperature, a runtime of the electric heating rod of the heat pump is acquired, for example by the control device. The limit temperature may be specified, for example, as a function of a geographic position of the building. The limit temperature may in particular correspond to a design temperature of the heat pump. Typically, the heat pump may be configured to operate efficiently most days of the year. In order to avoid expensive oversizing of the heat pump, the heat pump may be configured such that a loss of efficiency of the heat pump is accepted on the coldest days of the year when the outside temperature is very low. If the outside temperature falls below the limit temperature, the electric heating rod may provide additional heat output.

The limit temperature is usually a temperature below zero and may in particular be adjustable. For example, the limit temperature may be in a range between −15° C. and −5° C. When the outside temperature is above the limit temperature, the heating rod should not operate. When the heating rod is operated instead, this may be an indication of a defect or reduced efficiency of the heat pump.

The runtime of the heating rod may be acquired in seconds, minutes or hours, for example. The runtime of the heating rod means an integrated period of time during which the heating rod is in operation, i.e. consumes electrical energy or converts it into thermal energy. In particular, a runtime per day or per 24 hours is acquired. In addition, a runtime per week, per month, per year and/or overall runtime from the start of the heat pump's commissioning and/or from the last maintenance date of the heat pump may also be acquired.

The runtime of the heating rod is preferably acquired together with a respective time of the operation of the heating rod. In this way, it can later be evaluated at what times the heating rod is used and whether there are certain times when the heating rod is in operation particularly often. For example, after night setback, heating up too quickly may result in the heating rod being turned on to support the heat pump in order to reach a target value.

When the outside temperature is higher than the limit temperature, energy consumed by the heating rod may be detected, for example by the control device. The energy consumed may also be determined by measuring the power consumed and the runtime and multiplying them.

A first limit value for the runtime is set within a fixed period of time. For example, a maximum runtime may be set within a fixed period of one day or within 24 hours. In particular, the first limit value may be variable and may be defined as a function of various factors such as the time of year or a heating purpose. For example, a daily maximum runtime of several minutes or a few hours may be specified, in particular in a range from 15 minutes to 2 hours.

A second limit value is set for the energy consumed in the specified time period. It is thus possible to monitor in particular whether the energy consumed on a day or within 24 hours exceeds the second limit value. The aim is to prevent or to detect that the heating rod consumes more than the permitted amount of energy. In comparison to monitoring only the runtime alone, undesired operation of the heating rod can thus be reliably detected. An exemplary range for the second limit value may be between 1 and 5 kWh per day, in particular the second limit value may be 3 kWh per day.

When the first limit value and/or the second limit value is/are exceeded, a message is output. In particular, it is advantageous if a message is only output when both limit values are exceeded. In certain cases it may be desirable to tolerate high power consumption of the heating rod for a short period of time. This may be the case, for example, when a large amount of hot water is required in a short time, for example when filling a bathtub or the like. Such a short-term need for hot water can under certain circumstances not be met by the heat pump alone. The “short period of time” mentioned above is in particular no longer than one hour, preferably no longer than half an hour and particularly preferably no longer than 15 minutes. When the heat pump is in an emergency operating state, the message does not need to be output.

The message may in particular be a warning to draw the attention of a user of the heat pump to the fact that the heating rod is or was in operation longer and/or with higher energy consumption than permitted or desired. In the following, a user may in particular also be understood as a person or the like assigned to and/or responsible for the maintenance of the heat pump or for the operation of the heating system, such as a heating technician or heating installer.

Furthermore, the message may be any output that can be further processed electronically, for example in order to carry out a control intervention. For this purpose, the message may be transmitted, for example, via the network to the server or a cloud. In particular, the message may include a large amount of data about the operating state of the heat pump and/or the heating rod so that this data can be stored and/or processed further on the server or in the cloud, as will be described in more detail below.

The control intervention may be carried out automatically or may be suggested by the control device in response to the message so that it is only carried out after confirmation by a user. Alternatively, the message may already include the suggestion for the control intervention. Advantageously, a possible problem with the heat pump may be reported along with an appropriate solution to the problem.

The control intervention may include, for example, lowering the heat store target temperature. This may be particularly advantageous when the heat pump output is not sufficient to reach the heat store target temperature.

The control intervention may include increasing the heat store target temperature. This may be particularly advantageous when the heat pump output is sufficient to exceed the heat store target temperature. Furthermore, hot water may be stored in the heat store for a high demand (for example, to fill a bathtub).

The control intervention may include that a night setback is adjusted. Night setback may mean that a target temperature (e.g. of the flow and/or the heat store) is reduced overnight. The night setback allows for energy to be saved during the night. However, reducing the target temperature(s) overnight may have the advantage that a more modest operation of the heat pump in the morning is sufficient to reach the set temperature(s) during the day again. Operation of the heating rod can then be reduced, particularly at low outside temperatures.

The control intervention may include adjusting the heating times (or operating times). When, for example, it is detected that the heating rod is regularly used for heating in the morning hours (see night setback), an earlier time for starting a heating process by the heat pump may be set so that the target temperature(s) can be reached at a specified time without (or with less) help of the heating rod.

The control intervention may include adjusting a heating curve (i.e. a dependency of the target flow temperature on the outside temperature). A gradient and/or a parallel shift of the heating curve can be adjusted here.

The warning may be output by a control device of the heat pump to the user's terminal, in particular a mobile terminal such as a smartphone, tablet, laptop or other suitable device. The terminal may receive the warning in particular via a network, for example the Internet. The warning may be displayed additionally or instead via a display device of the control device.

The message or the warning may advantageously be used to avoid an undesired operating state of the heat pump. In particular, the warning may be used to determine that the heating rod has exceeded the first and/or the second limit value. Appropriate countermeasures can then be taken accordingly. For example, the warning may be an indication that the heat pump is operating inefficiently and that maintenance of the heat pump should be performed.

The control device of the heat pump performs closed-loop and/or open-loop control of the heat pump in particular as a function of one or more parameters, such as a target flow temperature, a target heat store temperature, the outside temperature and the like. The control device may receive the parameters from an external device, for example via a network. However, the parameters for performing closed-loop and/or closed-loop control of the heat pump may also be preprogrammed or stored in a local memory device. Furthermore, the heat pump may be controlled by means of a heating curve. Operating parameters are stored in the control device, in particular for emergency operation.

The acquired values of the outside temperature and/or the runtime of the heating rod and/or the energy consumed by the heating rod and/or the first limit value and/or second limit value and/or control parameters of the heat pump may be transmitted from the control device of the heat pump via the network to the cloud and/or to the server. This transmission of the values may take place independently of the message described above. The transmission may take place at regular time intervals, for example, so that a time series of data becomes available in the server and/or the cloud.

The cloud and/or the server can further process the transmitted data and values and, in particular, evaluate them as a function of the first limit value and the second limit value. For example, machine learning may also be used here, for example in order to detect or predict a decrease in the efficiency of the heat pump at an early stage. Accordingly, the message may also be generated and output by the server.

When the runtime within the specified period of time exceeds the first limit value and/or the energy consumed by the heating rod in the specified period of time exceeds the second limit value, the server may determine optimized control parameters for the operation of the heat pump and the heating rod and transmit the optimized control parameters via the network to the control device of the heat pump.

The first limit value and/or the second limit value may be defined as a function of an operating state of the heat pump. In particular, operating states may be defined depending on a heating purpose of the heat pump. For example, a distinction may be made between a first operating state for providing hot water (I e. service water such as drinking water, for example for a shower and/or bath) and a second operating state for providing heat for heating rooms.

In the first operating state, as described above, a high power consumption of the heating rod may be tolerated over a short period of time. When the heat pump is in the first operating state for a longer period of time, the second limit value may be increased accordingly.

In the second operating state, the heat pump should primarily be operated without the help of the heating rod. The first limit value and/or the second limit value may thus be reduced in the second operating state.

The first limit value and/or the second limit value may be adapted to the heating purpose by means of weighting. Correspondingly, the weighting of the limit values may be reduced in the first operating state. In the second operating state, the weighting of the limit values may be increased accordingly. In particular, the weighting may be set such that the message is output earlier when the heating rod is used for heating (second operating state).

The weighting may, for example, be configured such that the function reacts more sharply in the heating mode (second operating state), i.e. in particular from the set limit value (weighting=1) on, while an operation of the heating rod may be tolerated more (weighting>1) during service water heating (first operating state) since a high output is required in the short term in order to be able to provide sufficient hot water. In the first operating state in particular, providing hot water is therefore more important than avoiding operation of the heating rod. In order to make this possible, the permissible runtime (first limit value) or the permissible energy consumption (second limit value) may be increased by multiplying it by a weighting factor greater than one.

For example, a weighting factor equal to two may be used. This may, for example, be implemented in such a way that the heating rod may run for 30 minutes (first limit value) for heating and one hour for hot water preparation. Correspondingly, the second limit value may be defined such that 2 kWh of energy consumption by the heating rod for heating operation and 4 kWh of energy consumption by the heating rod for hot water preparation are permitted per day. The weighting with a factor of two is to be understood here in such a way that the heating rod may be operated twice as long or may consume twice as much energy in the first operating state as in the second operating state before suitable countermeasures are taken.

### BRIEF DESCRIPTION OF THE DRAWINGS

Further advantageous configurations are described in more detail below with reference to an exemplary embodiment illustrated in the drawings, to which the invention is not restricted, however.

In the figures:

FIG. 1 shows a heat pump with a heating rod according to an exemplary embodiment of the invention.

FIG. 2 illustrates a heating system including a heat pump according to an embodiment of the invention.

FIG. 3 shows a flow chart of a method according to the invention for operating a heat pump with a heating rod according to an exemplary embodiment of the invention.

### DETAILED DESCRIPTION OF THE INVENTION BASED ON EMBODIMENTS

In the following description of a preferred embodiment of the present invention, the same reference symbols designate the same or like components.

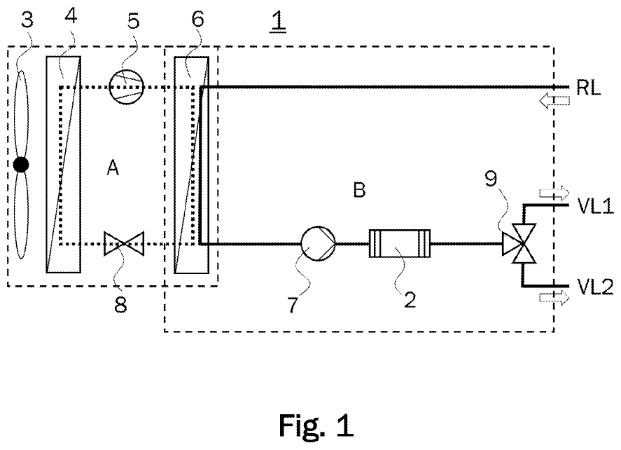

FIG. 1 shows a heat pump 1 according to an exemplary embodiment of the invention. The heat pump 1 shown is in particular an air-water heat pump 1, which is used as a heat generator for a building.

The air-water heat pump 1 may use the ambient air of the building as a heat source to heat the building. In FIG. 1, the heat pump 1 is divided into an outdoor unit A and an indoor unit B as a so-called split device. Accordingly, the outdoor unit A may be located in an outdoor area of the building, while the indoor unit B may be located in an indoor area of the building.

During operation, a fan 3 actively sucks in outside air and directs it to a heat exchanger, the evaporator 4. A refrigerant circulates therein which, due to its thermal properties, changes its state of matter even at low temperatures. The circuit of the refrigerant is shown in FIG. 1 in dotted lines.

When the refrigerant comes into contact with the “warm” outside air supplied, it heats up until it eventually begins to evaporate. Since the temperature of the resulting vapor is still relatively low, the vapor flows on to an electrically driven compressor 5. The latter increases the pressure, thereby also causing the temperature to rise. Once the refrigerant vapor has reached the desired temperature level, it flows on to the next heat exchanger, the condenser 6. Here it transfers its heat to a hydraulic line system (shown in bold solid lines in FIG. 1) and condenses.

The heat gained in this way may be used for heating or hot water preparation. Before the cooled refrigerant can be heated and compressed again, it first flows through an expansion valve 8. The pressure and temperature drop to the initial level and the cycle can be repeated. The expansion valve 8 may be electronically controlled.

The division of the components between the outdoor unit A and the indoor unit B is not fixed to that of FIG. 1 but may be variable. In particular, the condenser 6 may be arranged in the indoor unit B instead of in the outdoor unit A. Correspondingly, the connection between the outdoor unit A and the indoor unit B may be established by means of refrigerant lines or by means of hydraulic lines.

Water circulates in the hydraulic lines as a fluid heat transfer medium. In the condenser 6, the water absorbs heat from the refrigerant. In the condenser, heat is therefore transferred from the refrigerant to the heat transfer medium. A pump 7 arranged in the heating circuit may generate a desired volume or mass flow of the heat transfer medium. In FIG. 1, the pump 7 is arranged in the flow between the condenser 6 and the heating element 2. However, the arrangement of the pump 7 is not limited to this position. The pump 7 may also be arranged in the return RL, for example.

In the indoor unit B, an electric heating rod 2 is arranged which may function essentially like an electric immersion heater or continuous-flow heater and additionally heats the heat transfer medium if required. A control device 10 (not shown in FIG. 1) of the heat pump 1 may control, in particular, an electrical power consumption of the heating rod 2, a speed of the pump 7, the fan 3, a degree of opening of the expansion valve 8 and the compressor 5. The control device 10 can be arranged in the internal unit B, for example.

The indoor unit further includes a 3-way switching valve 9, at which the flow from the heat pump branches into two flow lines VL1, VL2. The first flow line VL1 may lead, for example, into a heating circuit of a heating system (room heating). The second flow line VL2 may be used, for example, as a hot water line (drinking water heating). Depending on requirements, the ratio of the volume or mass flow of the heat transfer medium between the first flow VL1 and the second flow VL2 may be adjusted via the 3-way switching valve 9.

The heat transfer medium flows from the heating system or drinking water lines of the building back to the heat pump 1 via a return RL. The circuit of the refrigerant between the condenser 6 and the evaporator 4 is also referred to as the primary circuit or generator circuit. The circuit of the heat transfer medium with flow and return is also referred to as the secondary circuit or consumer circuit.

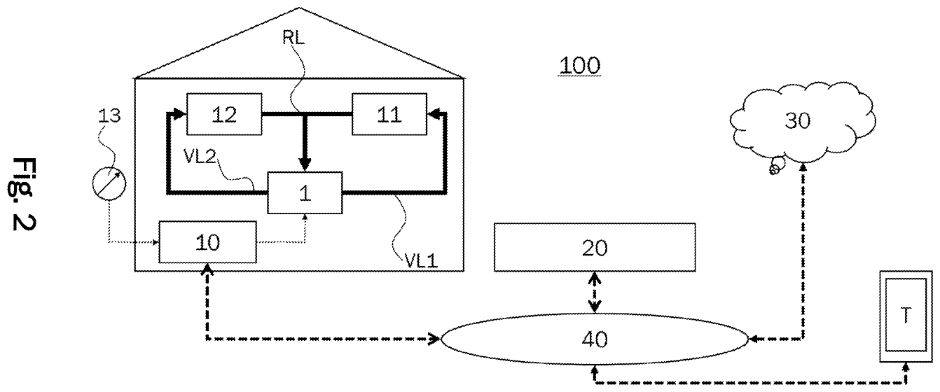

FIG. 2 shows a schematic diagram of a building with a heat pump 1 according to the invention. The control device 10 controls an operating state of the heat pump 1 and monitors operating parameters of the heat pump 1. The control device 10 acquires an outside temperature of the building via an outside temperature sensor 13.

A division of the heat pump 1 into an outdoor unit and an indoor unit is not shown in FIG. 2. However, the heat pump 1 may be divided as shown in FIG. 1 or may be configured as a monoblock device. From the heat pump 1, two flows VL1 and VL2 emerge. The first flow VL1 may, for example, lead to at least one radiator 11 for heating the building. The second flow VL2 for hot water may lead to a hot water store 12 or heat store.

The control device 10 is communicatively connected to a server 20 and a cloud 30 via a network 40. In addition, at least one terminal T, for example a smartphone or a laptop or another device, may be communicatively connected to the server 20, cloud 30 and control device 10 via the network 40. For communication via the network 40, the control device 10, the server 20, the cloud 30 and the terminal T each have suitable communication interfaces, the details of which are not described in more detail.

The heat pump 1 with flows VL1, VL2 and return RL and the consumers 11, 12, the control device 10, the server 20, the cloud 30, the network 40, the terminal T and the outside temperature sensor 13 belong to a heating system 100, although not all components are essential to the heating system 100. For example, the outside temperature may also be transmitted from the server 20 via the network 40 to the control device 10 instead of from an outside temperature sensor 13.

The server 20 and/or the cloud 30 are used as a memory and/or computing device for storing and evaluating data acquired and transmitted by the control device. In particular, the control device 10 acquires and transmits operating parameters of the heat pump 1, including a runtime and a power consumption of the heating rod 2. The control device 10 may also receive control parameters from the server 20 or the cloud 30 so that a control intervention in the operation of the heat pump can be performed.

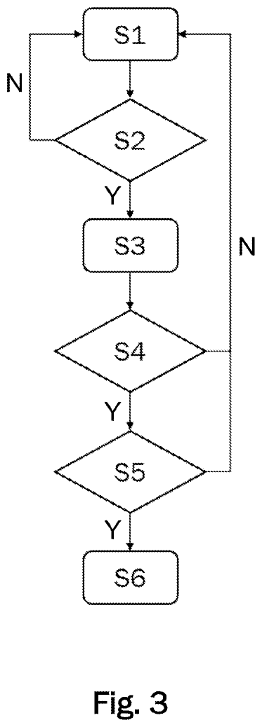

A method according to the invention for operating the heat pump 1 according to the invention in the heating system 100 according to the invention is described below with reference to a flow chart shown in FIG. 3. The aim of the method is to detect undesired operation of the heating rod 2 and to avoid it as far as possible or to enable measures to avoid the operation of the heating rod 2 to be taken.

In a first step S1, an outside temperature of the building is acquired. In the second step S2, the acquired outside temperature is compared with a specified limit temperature. The limit temperature may be specified, for example, as a function of a geographic location at which heat pump 1 is operated and/or as a function of a device type and a configuration of the heat pump 1. Usually, the limit temperature is a temperature below zero. For example, the limit temperature may be in a range between −15° C. and −5° C.

When the outside temperature is higher than the limit temperature (YES in step S2), a runtime of the electric heating rod 2 and an energy consumed by the heating rod 2 are acquired in the next step S3. The runtime and the energy consumption are acquired over a defined period of time, which may usually be several hours or, for example, a day. In particular, the defined period of time may start with a warm-up phase in the early morning and last 24 hours. The example below assumes a fixed period of one day (24 hours) that begins at 6:00 AM. The acquiring may be performed continuously at regular time intervals over the defined period of time, for example every minute or even several times per minute. Furthermore, the acquired data may be transmitted from the control device 10 to the server 20 and/or the cloud 30 via the network 40.

In particular, the acquired values of the outside temperature, the runtime of the heating rod 2 and the energy consumed by the heating rod 2 (or the current power consumption of the heating rod 2) may be transmitted in S1 from the control device 10 to the cloud 30 and/or the server 20 via the network 40.

When the outside temperature is lower than the limit temperature (NO in step S2), the method goes back to step S1. In this case, the runtime and the energy consumption of the heating rod 2 are not monitored using the method according to the invention. In this case, it may be necessary or desirable to operate the heating rod 2.

In the next step S3, the runtime and the energy consumption are evaluated in the specified period of time. In particular, in this step, the transmitted runtime data points may be integrated over the specified period of time in order to calculate the runtime of an entire day. The energy consumption may be calculated accordingly, wherein, for example, transmitted individual data points that indicate a current power consumption of the heating rod 2 are evaluated in order to calculate a total energy consumption of the heating rod in the specified period of time.

Steps S2 and S3 and the next steps S4, S5 and S6 may be carried out by the control device 10, the server 20 or the cloud 30. In the following steps S4 and S5, the calculated total values of the runtime and the energy consumption in the specified period of time are compared with respective limit values.

In step S4, it is determined whether the runtime exceeds a first limit value in the specified period of time. If this is the case (YES in S4), the method continues with step S5. If the first limit value is not exceeded (NO in S4), the daily runtime of the heating rod is within the permitted range and the method returns to the first step S1.

In step S5, it is determined whether the energy consumed by the heating rod 2 in the defined period of time exceeds a second limit value. If this is the case (YES in S5), the method continues with step S6. If the second limit value is not exceeded (NO in S5), then the daily consumed energy of the heating rod is within the permitted range and the method goes back to the first step S1.

In step S6, a message is generated and output. The message may be a warning, for example, which indicates that the runtime of the heating rod 2 exceeds the first limit value and/or that the energy consumption of the heating rod 2 exceeds the second limit value. The message may also indicate whether the heating rod 2 is currently in operation.

The message or warning may be output from the control device 10 or from the server 20 or the cloud 30 to a terminal T of a user of the heat pump 1 that is communicatively connected to the network 40. In addition or instead, the message may be output via a display device of the control device 10.

It should be noted that the comparisons with the first limit value and the second limit value in steps S4 and S5 depend on each other in the present example. In other words, both the first limit value and the second limit value must be exceeded (YES in S4 AND S5) before the message is generated and output in S6. However, the method according to the invention is not limited thereto. The method may also be carried out in such a way that exceeding just one of the two limit values (YES in S4 OR YES in S5) may be sufficient to generate and output the message in S6.

When the runtime exceeds the first limit value within the specified period of time (YES in S4) and/or the energy consumed by the heating rod 2 in the specified period of time exceeds the second limit value (YES in S5), the server 20 or the cloud 30 may determine optimized control parameters for the operation of the heat pump 1 and the heating rod 2 in step S6, and the optimized control parameters are transmitted to the control device 10 of the heat pump 1 via the network 40.

The features disclosed in the above description, the claims and the drawings may be important for the implementation of the invention in its various configurations both individually and in any combination.

1. A method for operating a heat pump that transfers heat to a fluid heat transfer medium circulating in a heating circuit, said method comprising:
acquiring an outside temperature;
acquiring a runtime of an electric heating rod of the heat pump and/or energy consumed by the heating rod, when the outside temperature is higher than a limit temperature; and
outputting a message, when the runtime exceeds a first limit value within a specified period of time or the energy consumed by the heating rod exceeds a second limit value in the specified period of time.

2. The method according to claim 1, wherein the message is a warning that is output by a control device of the heat pump to a terminal of a user of the heat pump or via a display device of the control device.

3. The method according to claim 1, wherein the message indicates whether the heating rod is currently in operation.

4. The method according claim 1, further comprising:
transmitting the acquired values of the outside temperature, the runtime of the heating rod (2) and the energy consumed by the heating rod from a control device of the heat pump via a network to a cloud or a server, wherein the cloud or the server:
evaluates the transmitted values as a function of the first limit value and the second limit value; and
generates and outputs the message.

5. The method of claim 4, wherein the cloud or server:
determines optimized control parameters for the operation of the heat pump and the heating rod and transmits the optimized control parameters via the network to the control device of the heat pump, when the runtime within the specified period of time exceeds the first limit value or the energy consumed by the heating rod in the specified period of time exceeds the second limit value.

6. The method according to claim 1, wherein the first limit value or the second limit value is specified as a function of an operating state of the heat pump.

7. A heating system for providing heat, comprising:
an outside temperature sensor for acquiring an outside temperature;
a heat pump for transferring heat to a fluid heat transfer medium circulating in a heating circuit of the heating system;
an electric heating rod for transferring heat to the fluid heat transfer medium;
a control device for controlling an operating state of the heat pump and the heating rod, said control device being configured to:
acquire a runtime of the heating rod or the energy consumed by the heating rod, when the outside temperature is higher than a limit temperature; and
output a message, when the runtime exceeds a first limit value within a specified period of time or the energy consumed by the heating rod in the specified period exceeds a second limit value.

8. The heating system according to claim 7, wherein the control device is connected to a cloud or a server via a network and the control device is further configured to:
transmit the acquired values of the outside temperature, the runtime of the heating rod and the energy consumed by the heating rod to the cloud or the server via the network;
receive optimized control parameters for the operation of the heat pump and the heating rod via the network from the cloud or server, when the runtime within the specified period of time exceeds the first limit value or the energy consumed by the heating rod in the specified period of time exceeds the second limit value; and
control the operating state of the heat pump and the heating rod depending on the optimized control parameters.

9. The heating system according to claim 7, further comprising a heat store, wherein the control device is configured to determine a storage temperature of the heat store as a function of the acquired runtime of the heating rod or the energy consumed by the heating rod and as a function of the first or second limit value.

10. The heating system according to claim 7, wherein the first limit value or the second limit value is defined as a function of an operating state of the heat pump.

11. The method according to claim 2, wherein the message indicates whether the heating rod is currently in operation.

12. The method according to claim 2, wherein the first limit value or the second limit value is specified as a function of an operating state of the heat pump.

13. The method according to claim 3, wherein the first limit value or the second limit value is specified as a function of an operating state of the heat pump.

14. The method according to claim 4, wherein the first limit value or the second limit value is specified as a function of an operating state of the heat pump.

15. The method according to claim 5, wherein the first limit value or the second limit value is specified as a function of an operating state of the heat pump.

16. The heating system according to claim 8, further comprising a heat store, wherein the control device is configured to determine a storage temperature of the heat store as a function of the acquired runtime of the heating rod or the energy consumed by the heating rod and as a function of the first or second limit value.

17. The heating system according to claim 8, wherein the first limit value or the second limit value is defined as a function of an operating state of the heat pump.

18. The heating system according to claim 9, wherein the first limit value or the second limit value is defined as a function of an operating state of the heat pump.
